(19) United States
(12) Patent Application Publication
(10) Pub. No.: US 2023/0222046 A1
(43) Pub. Date: Jul. 13, 2023

(54) DEVICE STATE MONITORING SYSTEM

(71) Applicants: MITZBA DENYOSHA CO., LTD., Tokyo (JP); TOKYO INSTITUTE OF TECHNOLOGY, Tokyo (JP); PIECAKE, INC., Kanagawa (JP); KYOWA SEIKO CO., LTD., Nagano (JP)

(72) Inventors: Yoh OZAKI, Tokyo (JP); Hiroshi DEGUCHI, Tokyo (JP); Tadashi KURATA, Kanagawa (JP); Yasunari ISHIZUKA, Kanagawa (JP); Hiroyuki HASHIBA, Nagano (JP); Keisuke NARUSE, Nagano (JP)

(73) Assignees: MITZBA DENYOSHA CO., LTD., Tokyo (JP); TOKYO INSTITUTE OF TECHNOLOGY, Tokyo (JP); PIECAKE, INC., Kanagawa (JP); KYOWA SEIKO CO., LTD., Nagano (JP)

(21) Appl. No.: 18/008,762

(22) PCT Filed: Jun. 8, 2021
(86) PCT No.: PCT/JP2021/021712

§ 371 Date: Dec. 7, 2022

(30) Foreign Application Priority Data
Jun. 8, 2020 (JP) 2020-099607

(51) Int. Cl. G06F 11/34; G06F 11/30

(52) U.S. Cl. CPC G06F 11/3447; G06F 11/3013

(57) ABSTRACT

To provide a device state monitoring system capable of monitoring an operating status of a device in detail. The device state monitoring system includes: a collection unit that acquires, from a device which executes a series of processes, operating information about the device in a time-series manner; and a process determination unit that performs matching of the operating information acquired by the collection unit with matching data obtained by modeling the operating information acquired from the device when the device is in each of the processes, and determines process information concerning the process which the device is executing.

### TECHNICAL FIELD

The present invention relates to a device state monitoring system which monitors an operating state of a device.

### BACKGROUND ART

Heretofore, there has been known a technique to perform monitoring of a production status or operating status in production facilities in real time.

### CITATION LIST

### Patent Literature

PTL 1: JP2019-095879A

### SUMMARY OF INVENTION

### Technical Problem

For example, in revenue management in a factory or the like, an operating status of a device or the like serves as one barometer of the revenue management. In the past, reviewing of plans and actual performances or improvement suggestions have been being performed at intervals of a fixed period such as on a monthly basis. However, the operating state of a device includes not only a main operation such as a processing operation for directly producing a processed product but also a preparatory operation such as set-up change, a subsequent operation, waiting, or a troubleshooting operation such as stoppage caused by a trouble or handling of the trouble. Therefore, merely recognizing operating or non-operating of a main operation is not enough to accurately perform revenue management based on the operating status of a device.

The present invention has been made in view of such circumstances, and has an object to provide a device state monitoring system capable of monitoring an operating status of a device in detail.

### Solution to Problem

To solve the above-mentioned issues, a device state monitoring system according to the present invention includes a collection unit that acquires, from a device which executes a series of processes, operating information about the device in a time-series manner, and a process determination unit that performs matching of the operating information acquired by the collection unit with matching data obtained by modeling the operating information acquired from the device when the device is in each of the processes, and determines process information concerning the process which the device is executing.

### Advantageous Effects of Invention

In a device state monitoring system according to the present invention, it is possible to monitor an operating status of a device in detail.

### BRIEF DESCRIPTION OF DRAWINGS

FIG. 1 is a schematic functional block diagram illustrating a functional configuration of a device state monitoring system in the present embodiment.

FIG. 2 is a diagram used to explain a relationship between production lines and cells.

FIG. 3 is a diagram visually illustrating a series of processes which a welding system is able to execute.

FIG. 4 is a flowchart used to explain process information determination processing which is performed by the device state monitoring system.

FIG. 5 is a diagram illustrating, in a time-series manner, an example of operating information which a collection unit has acquired.

FIG. 6A is an explanatory diagram illustrating an example of displaying of process information.

FIG. 6B is an explanatory diagram illustrating an example of displaying of process information.

FIG. 6C is an explanatory diagram illustrating an example of displaying of process information.

FIG. 7 is a flowchart used to explain failure prediction processing which is performed by the device state monitoring system in the present embodiment.

FIG. 8 is a sequence diagram used to particularly explain processing in the production line and the device state monitoring system.

FIG. 9 is a flowchart used to explain alternative product suggestion processing which is performed by the device state monitoring system.

### DESCRIPTION OF EMBODIMENTS

An embodiment of a device state monitoring system according to the present invention is described based on the accompanying drawings. In the present embodiment, a case where the device state monitoring system according to the present invention is applied to state monitoring for a welding or processing system, which is used for welding or various processing or forming operations for arc welding or the like is described as an example. Hereinafter, the welding or processing system is simply referred to as a “welding system”. Moreover, simply a word “welding” can mean “welding or processing”.

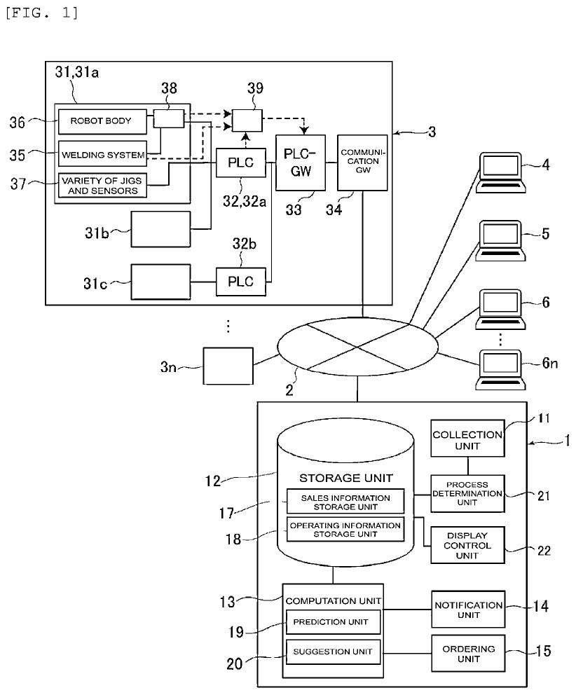

FIG. 1 is a schematic functional block diagram illustrating a functional configuration of a device state monitoring system 1 in the present embodiment.

In the following description, the term “user” mainly refers to a person or company that operates and uses a device in user facilities (factory) including a welding system 35. The term “seller” refers to a person or company that sells a device (including components attached to the device) to the user, maintains the device, or modifies the device. The term “manufacturer” refers to a person or company that manufactures a device or components thereof, which the seller sells to the user, and sells the device or components to the seller. The terms “device” or “component” can include a welding system 35, a robot body 36, a variety of jigs and sensors 37, and a robot controller 38, which are included in a cell 31, a dedicated circuit board 39, or their components, a PLC 32, a PLC-GW 33, and a communication GW 34, or components included in them.

The device state monitoring system 1 is connected to a network 2. The device state monitoring system 1 is connected to production lines 3, . . . , and 3n, a seller terminal 4, a manufacturer terminal 5, and user terminals 6, . . . , and 6n via the network 2.

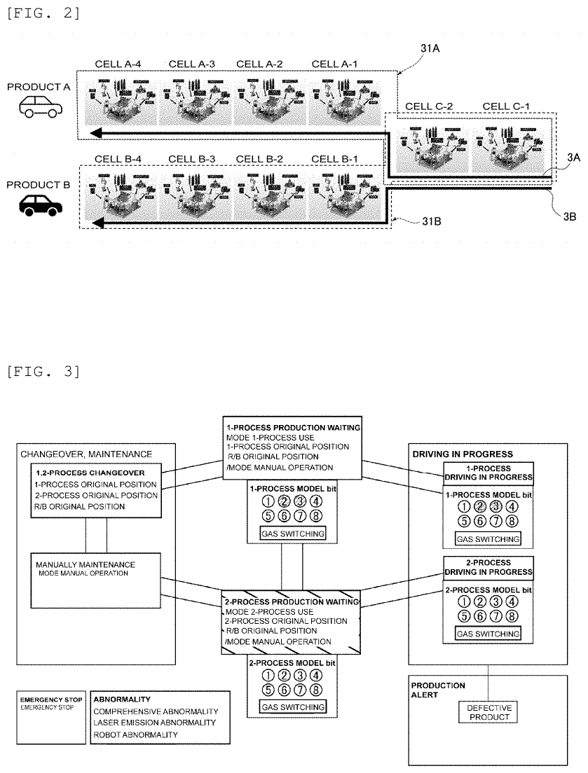

The production lines 3, . . . , and 3n are facilities which are managed by the user and which include a plurality of cells 31. The cell 31 is a concept with a small section included in the production line 3 set as a unit, and one and the same production line 3 can include a plurality of cells 31a, 31b, and 31c. Here, FIG. 2 is a diagram used to explain a relationship between the production lines 3 and the cells 31.

For example, a production line 3A, which is used to manufacture a product A, includes a cell 31A, which is represented by cells A-1 to A-4 and cells C-1 and C-2. A production line 3B, which is used to manufacture a product B, includes a cell 31B, which is represented by cells B-1 to B-4 and the cells C-1 and C-2. Furthermore, as with the cells C-1 and C-2, the cell 31 can be included in a plurality of production lines 3.

While a plurality of user facilities (of respective different users) which is managed by a plurality of users can be connected to the network 2, since the user facilities have almost similar configurations, here, only one user facility is illustrated for description.

The production line 3 includes a cell 31, a PLC 32, a PLC-GW 33, and a communication GW 34.

The cell 31 includes a welding system 35, a robot body 36, a variety of jigs and sensors 37, and a robot controller 38.

The welding system 35 includes a welding machine, a feeder control box, a wire supply device, a welding torch, a torch cable, and the like. The robot body 36 is a robot which is operated to automatically perform welding with use of the welding system 35. The variety of jigs and sensors 37 include jigs such as a positioner, a variety of sensors such as a position sensor, a temperature sensor, and a vibration meter, an imaging device, and the like.

The welding system 35 and the robot body 36 are connected to the robot controller 38. The robot controller 38 controls the welding system 35 and the robot body 36 based on the control of a programmable logic controller (PLC) 32.

The PLC 32 is connected to the robot controller 38 and the variety of jigs and sensors 37, and controls these based on preliminarily programmed control contents, thus superiorly controlling the welding system 35, the robot body 36, and the variety of jigs and sensors 37 (the cell 31).

Moreover, the welding system 35, the robot controller 38, and the PLC 32 are connected to a dedicated circuit board 39. The dedicated circuit board 39 is configured to acquire operating information including, for example, various physical quantities concerning welding from the welding system 35, the robot controller 38, and the PLC 32, and is equipped with a dedicated central processing unit (CPU) for computation.

The operating information corresponds to all of the pieces of information able to be digitized (able to be output) which is obtained from the production line 3. The operating information includes, for example, driving information about a motor which drives the shaft of the robot body 36, which is obtained from the robot controller 38, or welding conditions which are obtained from the welding device. The driving information about the motor includes, for example, a motor current command value, an actual current value, a motor speed command value, an actual speed, or encoder position information. The welding conditions include, for example, a welding method, a welding current, a welding voltage, a welding wire advancing speed, a welding speed, a welding waveform adjustment amount, an extrusion amount, a forward movement angle and backward movement angle of a welding torch, an aim angle, an aim position, a shielding gas flow rate, a weaving condition, an arc sensor condition, and a welding position offset amount at the time of multi-layer welding. Moreover, the operating information includes various values which are measured from the welding system 35, the robot body 36, and the variety of jigs and sensors 37, which operate based on these welding conditions. Such pieces of operating information are measured by respective predetermined measuring devices.

Moreover, the operating information includes, for example, captured image data about a welded portion captured by an imaging device, an outer appearance of weld bead which is obtained by processing the captured image data, a weld reinforcement height of bead, a bead width, and an amount of spatter generation. Additionally, the operating information includes a penetration amount which is obtained from a penetration measuring device and an arc sound waveform which is obtained from a sound pick-up device.

The PLC 32a is, for example, as illustrated in FIG. 1, connected to a plurality of cells 31a and 31b. For example, a different cell 31c is provided with a separate PLC 32b, and the PLC 32b is also connected to the cell 31c, which has a configuration almost similar to that of the cell 31a.

The PLC 32 and the dedicated circuit board 39 are connected to the PLC-GW (PLC-gateway) 33 and the communication GW (communication gateway) 34 in a sequential order. The PLC-GW 33 converts a communication protocol for the plurality of PLCs 32a and 32b and the dedicated circuit board 39, which are connected to the PLC-GW 33, into a predetermined format which is able to be used by the device state monitoring system 1. The PLC-GW 33 transmits the above-mentioned operating information obtained from the dedicated circuit board 39 to the device state monitoring system 1 via the communication GW 34 and the network 2. The PLC-GW 33 acquires operating information at a constant frequency and then transmits the acquired operating information. At this time, operating information concerning the PLC-GW 33 or the communication GW 34 as well as operating information about the cell 31 can also be transmitted to the device state monitoring system 1.

Furthermore, devices which operate without being controlled by the PLC 32 or the robot controller 38 (for example, a pressing machine and a welding machine alone) are also included in the devices connected to the dedicated circuit board 39. In this case, the dedicated circuit board 39 is directly connected to such devices, and acquires and transmits acquirable electrical signals, for example, signals simply indicating whether each device is operating (for example, a 24 V contact output), such as ON and OFF signals.

The devices which provide information to the device state monitoring system 1, such as the welding system 35, the robot body 36, and the variety of jigs and sensors 37 (hereinafter simply referred to as “devices”), are assigned the respective specific IDs. Moreover, components configuring the device (such as a welding torch, a welding wire, and a welding tip) and an element configured with the device or components (for example, a shaft of the robot body 36) are also assigned the respective specific IDs. Pieces of information to be provided to the device state monitoring system 1 are transmitted in a discriminable manner while being associated with such IDs.

The seller terminal 4 is a terminal (computer) which the seller uses. The seller uses the seller terminal 4 to access information stored in the device state monitoring system 1, which is subject to disclosure to the seller terminal 4, or receive a notification from the device state monitoring system 1.

The manufacturer terminal 5 is a terminal which the manufacturer uses. The manufacturer uses the manufacturer terminal 5 to access information stored in the device state monitoring system 1, which is subject to disclosure to the manufacturer terminal 5, or receive a notification from the device state monitoring system 1.

The user terminals 6, . . . , and 6n are terminals which the respective users use. While a plurality of user terminals 6, . . . , and 6n which are managed by a plurality of users (different users) is connected to the network 2, the user terminals 6, . . . , and 6n have almost similar configurations and are, therefore, described simply as a “user terminal 6”. The user uses the user terminal 6 to access information stored in the device state monitoring system 1, which is subject to disclosure to the user terminal 6, or receive a notification from the device state monitoring system 1.

The device state monitoring system 1 is, for example, a system using Software as a Service (SaaS), which uses cloud computing. The device state monitoring system 1 includes a collection unit 11, a process determination unit 21, a storage unit 12, a display control unit 22, a computation unit 13, a notification unit 14, and an ordering unit 15.

The collection unit 11 acquires, for example, operating information concerning the device such as the welding system 35 and various physical quantities from the production line 3 via the network 2. The collection unit 11 records the acquired operating information and the like on an operating information storage unit 18 via the process determination unit 21.

The process determination unit 21 contains preliminary stored matching data to be used for matching. The process determination unit 21 collates the matching data and the operating information acquired by the collection unit 11 with each other, thus determining a process which the device is executing from the operating information and generating process information. The process determination unit 21 stores the generated process information as well as the matching data in the operating information storage unit 18. The details of the process determination unit 21 are described below.

The storage unit 12 includes a sales information storage unit 17 and the operating information storage unit 18.

The operating information storage unit 18 acquires operating information obtained from the collection unit 11 via the process determination unit 21, and stores the acquired operating information therein. Moreover, the operating information storage unit 18 stores process information generated by the process determination unit 21 and matching data associated with the process information while associating them with each other.

The display control unit 22 reads operating information or process information stored in the operating information storage unit 18, and performs control to display the read information in the designated format. Specifically, upon receiving a request to display operating information or the like from the seller terminal 4, the manufacturer terminal 5, or the user terminal 6, the display control unit 22 reads information in response to the request and displays the read information to the seller terminal 4, the manufacturer terminal 5, or the user terminal 6 in a predetermined format.

Furthermore, the sales information storage unit 17, the computation unit 13, the notification unit 14, and the ordering unit 15 execute respective functions using the generated process information and are, therefore, described below in detail after processing for generating the process information is described.

Next, processing which is performed by the device state monitoring system 1 in the present embodiment is described in detail. In the following description, the processing is described by use of an example in which the device state monitoring system 1 performs the processing while aiming at the cell 31. To apply welding to a given processing target, the cell 31 executes a series of processes. Thus, the series of processes to be executed by the cell 31 includes not only a main operation for actually applying welding (a processing operation for directly producing a processed product) but also an operation which occurs concomitantly with the main operation, such as a preparatory operation such as set-up change or waiting, a subsequent operation, a troubleshooting operation such as stoppage caused by a trouble, such as “set-up change”, “waiting in progress”, “driving in progress”, and “occurrence of abnormality”. Thus, the term “process” is a concept which can include various operations the device is able to actually perform.

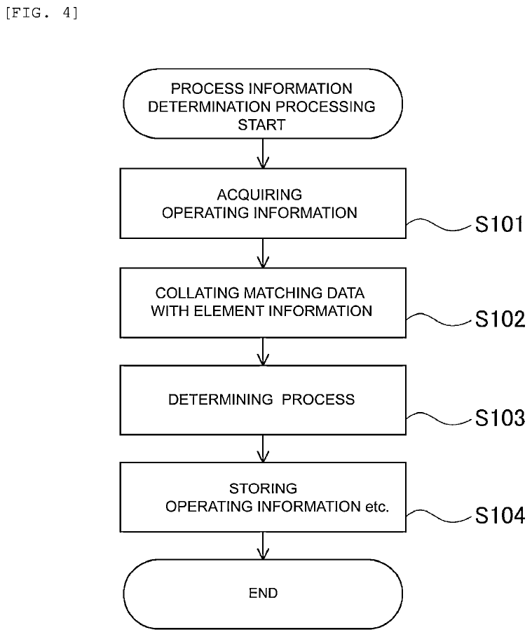

Here, FIG. 3 is a diagram visually illustrating a series of processes which the cell 31 is able to execute.

These processes are information which does not depend on the model of the cell 31 serving as an acquisition source of operating information or on a processing target for the cell 31 and which is able to be compared between the cell 31 and a device other than the cell 31, and are information which is also usable in the conduct of, for example, revenue management or budget control.

For example, if it is possible to accurately recognize at what rate and in what flow each process is being executed from set-up change (changeover) to driving, it is possible to perform a comparison between plans and actual performances or analysis of operating efficiency.

It is possible to perform revenue management or budget control of the cell 31 by supplementing recording or calculation of operating information which depends on the cell 31 with human resources. However, if it is possible to collect, automatically and in real time from operating information, process information concerning a process which the cell 31 is executing, it is possible to perform analysis for revenue management or budget control in more detail and in a more efficient manner.

Therefore, the device state monitoring system 1 in the present embodiment automatically acquires operating information from the cell 31. Moreover, the device state monitoring system 1 determines a process which the cell 31 is executing based on the acquired operating information by performing matching between the operating information and the preliminarily stored matching data, thus being able to generate process information from the operating information automatically and in real time. In the following description, processing for determining process information is described with reference to a flowchart.

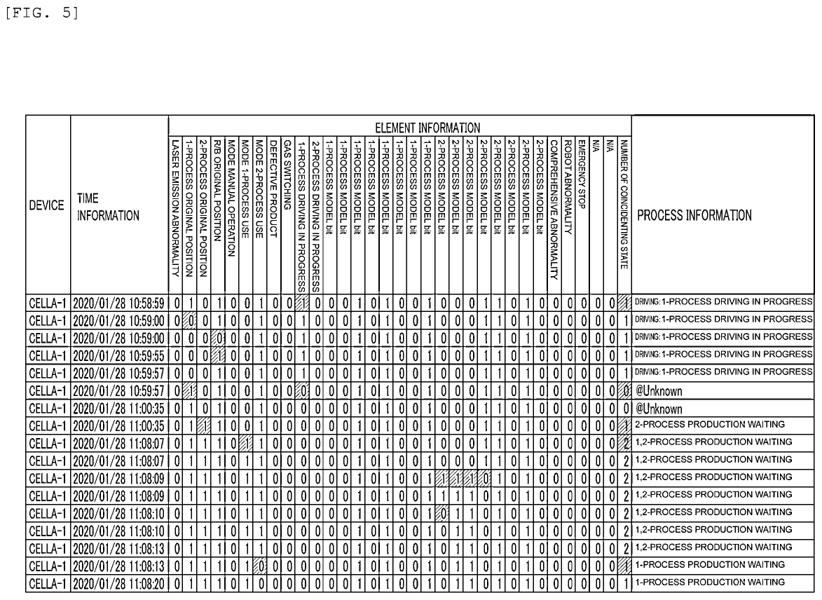

FIG. 4 is a flowchart used to explain process information determination processing which is performed by the device state monitoring system 1. The process information determination processing is repeatedly performed, for example, at predetermined timing, such as each time the collection unit 11 acquires operating information, or at intervals of a predetermined time.

In step S101, the collection unit 11 acquires operating information from the cell 31 via the network 2. The operating information to be used here is information required to determine a process which the cell 31 is executing out of the above-mentioned pieces of operating information, and includes mainly time information and element information. The time information is information representing the date and time at which the operating information has been output from the cell 31. The element information is information concerning a plurality of operating elements included in the cell 31, and is, for example, information capable of representing, with binary values of “0” and “1”, whether a predetermined state is established in each operating element. The element information is information indicating an internal state specific to the device of the cell 31 (dependent on the cell 31), and is a type of information difficult to generalize and compare with another device as with process information.

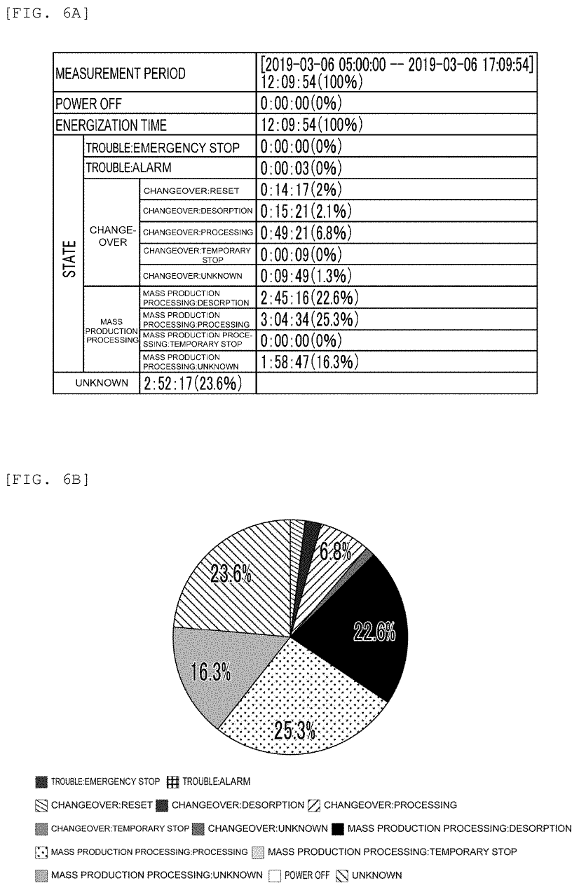

Here, FIG. 5 is a diagram illustrating, in a time-series manner, an example of operating information which the collection unit 11 has acquired. In FIG. 5, an example of acquiring element information as 32-bit information from the cell 31 (cell A-1) is illustrated. Thirty-two pieces of element information illustrated in FIG. 5 as an example correspond to respective items written together with each process illustrated in FIG. 3, and, in FIG. 3, element information related to each process is shown. For example, element information required to determine “1-process production waiting” is “mode 1-process use”, “1-process original position”, and the like.

The element information is, for example, information concerning whether a laser emission abnormality is occurring in the cell 31, and is represented by “1” in a case where a laser emission abnormality is occurring and represented by “0” in a case where no laser emission abnormality is occurring. Moreover, another piece of element information is information concerning whether a movable element (for example, a positioner jig) which is used for a given process (for example, 1-process) is in an original position thereof, and is represented by “1” in a case where the movable element is in the original position and represented by “0” in a case where the movable element is not in the original position.

In step S102, the process determination unit 21 collates matching data contained in the process determination unit 21 itself with element information (operating information) acquired from the collection unit 11.

The matching data is data defined by modeling a pattern of element information which may be obtained from the cell 31 when the cell 31 is executing each process. For example, the matching data is data for defining that, in element information, in a case where a given operating element is in the original position and “mode 1-process use” is established, the cell 31 is executing a process of “1-process production waiting”. Furthermore, “mode 1-process use” refers to a state in which an instruction for using a 1-process has been received from the operator.

In step S103, the process determination unit 21 determines a process which the cell 31 is executing estimated from the operating information, based on a result of collation of the matching data. Specifically, the process determination unit 21 extracts, from the matching data, a pattern coincident with a pattern of element information targeted for comparison, and generates process information from a process defined by the extracted pattern.

In step S104, the process determination unit 21 stores the operating information acquired from the collection unit 11 in the operating information storage unit 18 as needed while associating the operating information with the matching data (process information).

Since, in this way, process information is associated with operating information by the process determination unit 21, it is possible to generate process information able to be relatively compared with another device from internal operating information which is dependent on the cell 31 (convert operating information into process information). With regard to the process information, clearly specifying a process which the cell 31 is executing (in FIG. 3, “2-process production waiting”) by, for example, changing a color thereof in conjunction with, for example, an association chart of processes illustrated by an example in FIG. 3 enables recognizing the current situation in real time.

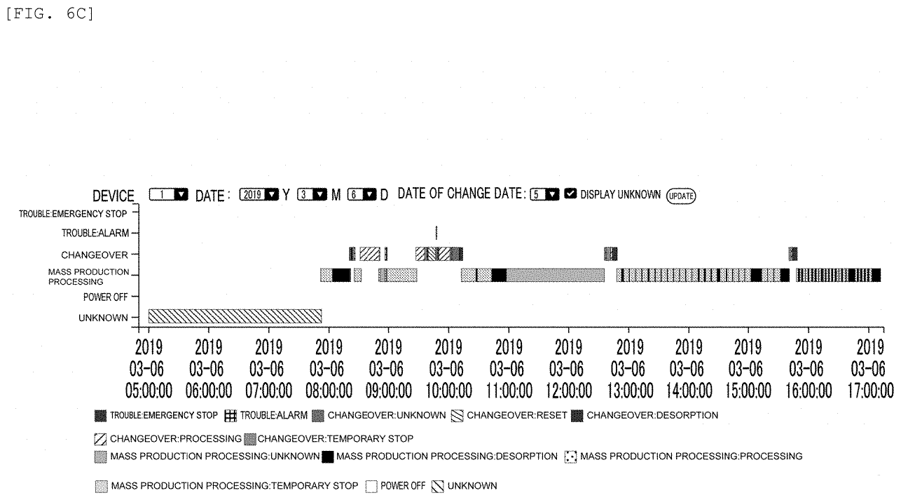

Moreover, upon receiving an instruction for displaying process information from, for example, the user terminal 6, the display control unit 22 displays the process information in various forms, thus enabling, for example, the user to visually recognize the actual performance of a process which has been executed by the cell 31. For example, FIGS. 6A to 6C are explanatory diagrams illustrating examples of displaying of process information.

As illustrated in FIG. 6A, the display control unit 22 is able to display, in tabular form, the rate of each process which the cell 31 executed in a given fixed period, based on process information. Moreover, as illustrated in FIG. 6B, the display control unit 22 is also able to display, in pie chart form, the rate of each process which the cell 31 executed. Additionally, as illustrated in FIG. 6C, the display control unit 22 is also able to perform displaying in Gantt chart form in such a manner that processes which the cell 31 executed are browsable on the time axis.

Such process information is associated with data preliminarily created and input by, for example, the user and is thus able to be utilized for various pieces of analysis. For example, the user uses process information, thus being able to perform budget control, prediction of order point of materials, and the like. The seller and the manufacturer use the obtained process information, thus being able to perform prediction of demand for consumables, prediction of failure of devices or components, suggestion for automatic ordering of consumables or materials, prediction of order point of materials, prediction of manufacturing of materials, and the like.

For example, the device state monitoring system 1 is able to obtain process information serving as an actual performance of the cell 31 in real time and in an accurate manner. Accordingly, the device state monitoring system 1 includes a required analysis unit, thus being able to automatically process analysis concerning price budge control of a value to be output (for example, a profit to be obtained from a finished product) with respect to budgetary input resources (for example, material cost, raw material cost, and labor cost).

Specifically, the device state monitoring system 1 is able to accurately recognize all of the processes which the cell 31 executes in the process of operation, and is, therefore, able to perform revenue management not only by simply comparing input resources required for direct processing (main operation) with the number of processed products obtained for a given fixed period but also by taking into consideration, for example, input resources pertaining to a preparatory operation and a subsequent operation other than an operating time (such as a set-up change operation and a waiting time) or a trouble.

Moreover, the device state monitoring system 1 determines a process by preliminarily generating matching data obtained by associating operating information and process information with each other, and is, therefore, able to generate process information even from any device as long as there is matching data. Thus, even with respect to such an old machine as not to be controlled by, for example, the PLC 32 or the robot controller 38, the device state monitoring system 1 is able to generate process information via performing matching, as long as being capable of acquiring operating states such as ON and OFF signals from various output terminals. Thus, the device state monitoring system 1 is able to be applied to any device or any factory without dependence on oldness and newness of the device.

Next, as an example of processing utilizing process information generated by the device state monitoring system 1, an example in which the seller performs prediction of failure of a device or component with use of the process information is specifically described. To perform failure prediction, the device state monitoring system 1 includes the sales information storage unit 17 of the storage unit 12, the computation unit 13, the notification unit 14, and the ordering unit 15, which are illustrated in FIG. 1.

The sales information storage unit 17 records sales information about a device or component which the seller sold to the user. The sales information can include a sales history of a device or component which the seller sold to the user, a maintenance history of a device or component, or a modification history of a device or component. The sales information storage unit 17 has, for example, a tree structure with user information (such as user names) set as the top. For example, the sales information storage unit 17 sequentially records, in levels lower than the user information, information concerning the production line 3 (user facilities), information concerning the cell 31, information concerning a device included in the cell 31, and information concerning an element or component included in the device. The sales information storage unit 17 records these pieces of information with the abovementioned device-specific IDs assigned thereto.

The sales information storage unit 17 acquires, from the seller terminal 4, information concerning sales, maintenance, and modification which the seller performed to the user, and records such acquired information thereon. The sales information storage unit 17 retains, in addition to the sales information, information which the seller needs for sales, such as the required stock quantity of respective devices or components for each user. The sales information storage unit 17 also retains alternative product information about alternative products to respective devices or components. These pieces of information are transmitted from the seller terminal 4 as needed and are then recorded (updated, added, or corrected) on the sales information storage unit 17. The sales information storage unit 17 performs recording while associating such pieces of information with operating information recorded on the operating information storage unit 18. The association is performed with use of an ID.

The computation unit 13 includes a prediction unit 19 and a suggestion unit 20.

The prediction unit 19 predicts timing of failure (a predicted time point of failure) of a device or component by performing machine learning based on sales information and operating information (hereinafter, the term simply referred to as “operating information” also having the potential to include information with which process information is associated). Specifically, the prediction unit 19 performs machine learning on past sales information and operating information obtained from when the device started operating to when the device failed, which have been accumulated in the sales information storage unit 17 and the operating information storage unit 18, and thus generates an estimation model for estimating a time point of failure of the device or component. For example, the prediction unit 19 evaluates changes of operating information occurring until a time point of failure in a qualitative manner (in a probability distribution manner), and performs machine learning thereon. The prediction unit 19 obtains, from the obtained estimation model, a difference from an operating state occurring until the current device or component fails, and obtains a curve (transition) occurring until the predicted time point of failure. The prediction unit 19 is configured to update the estimation model each time past sales information and operating information obtained from when the device started operating to when the device failed are obtained, and, additionally, to also accumulate information concerning the production line 3 of another user, thus performing high-accuracy prediction of a time point of failure.

For example, with regard to a prediction of failure of a motor of the robot body 36, the prediction unit 19 performs machine learning on operating information concerning the motor with respect to cycles occurring until a failure, and generates an estimation model obtained in consideration of influences which blunting of responsiveness, change of load factor, and ambient temperature and vibrational frequency serving as additional information exert on failures. As the machine learning, an approach such as deep learning can be used, and, additionally, various approaches such as supervised learning, unsupervised learning, semi-supervised learning, reinforcement learning, transduction, and multitask learning can be applied. The same also applies to the suggestion unit 20.

Here, the term “failure” refers to a state in which the device or component is unable to be used for welding, and includes a state in which a replacement with a new device or component is needed. Moreover, the term “failure” includes a state in which the device or component is able to be used for welding but is not able to attain a desired welding quality.

The suggestion unit 20 performs machine learning based on sales information, operating information, and component information and thus suggests an alternative product to the device or component. Specifically, the suggestion unit 20 performs machine learning on past sales information and operating information accumulated in the sales information storage unit 17 and the operating information storage unit 18, and thus generates an estimation model for conducting the evaluation of a case where the device or component in current use has been replaced with an alternative product. The suggestion unit 20 determines, based on the evaluation of an alternative product obtained from the estimation model, whether there is an alternative product more favorable than the device or component in current use.

The notification unit 14 performs notification to the user terminal 6 based on estimation results obtained from the prediction unit 19 and the suggestion unit 20. For example, in a case where the time to the predicted time point of failure is less than a notification time which is a preliminarily set time for performing notification, the notification unit 14 performs notification to the user terminal 6 by e-mail or the like. Moreover, in a case where there is an alternative product which should be suggested to the user, the notification unit 14 performs notification to the user terminal 6 by e-mail or the like.

The ordering unit 15 automatically performs order processing of a device or component a failure of which is estimated, based on the estimation result obtained from the prediction unit 19. For example, in a case where the time to the predicted time point of failure is less than an ordering time which is a preliminarily set time for placing an order, the ordering unit 15 records information about the applicable component on the sales information storage unit 17, and transmits the content thereof to the seller terminal 4. The seller delivers a device or component to the user based on such a notification.

The device state monitoring system 1 configured as described above associates operating information obtained from the production line 3 with, for example, detailed information concerning a device or component in use at the production line 3, which is already recorded on the sales information storage unit 17, and information concerning the production line 3, and then records the associated pieces of information. Accordingly, it is possible to perform machine learning while more reflecting a usage environment of the user than performing machine learning with only operating information obtained from a device or component.

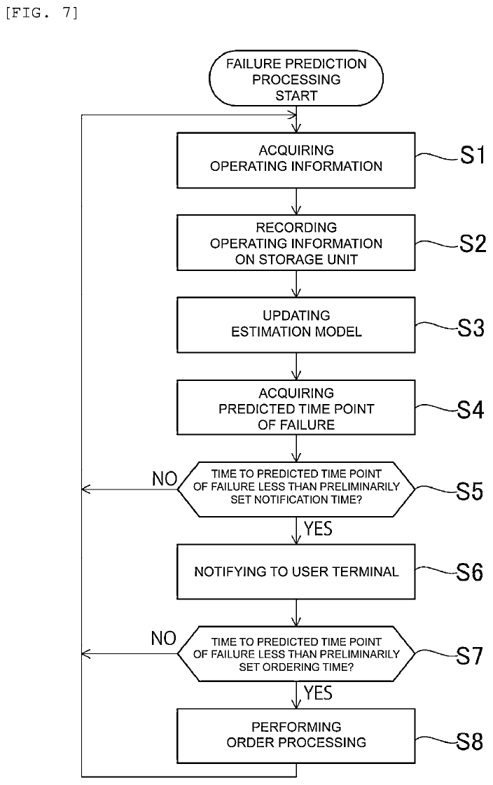

FIG. 7 is a flowchart used to explain failure prediction processing which is performed by the device state monitoring system 1 in the present embodiment.

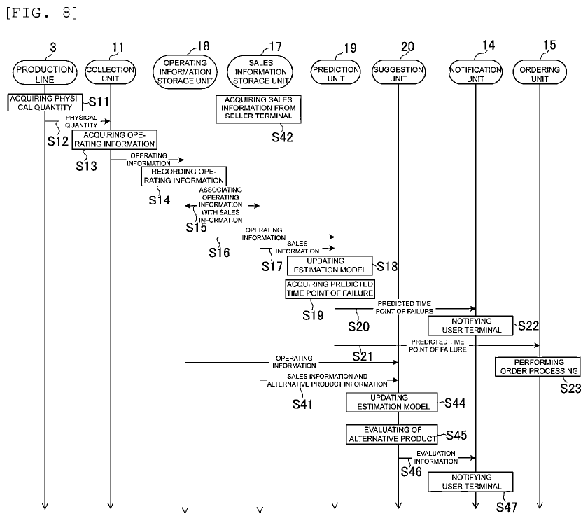

FIG. 8 is a sequence diagram used to particularly explain processing in the production line 3 and the device state monitoring system 1.

In step S1 illustrated in FIG. 7, the collection unit 11 acquires operating information. Thus, the collection unit 11 acquires, via the network 2, a physical quantity (step S11 illustrated in FIG. 8) concerning welding which the production line 3 has acquired from the device or component (step S12). The collection unit 11 performs the above-mentioned desired processing on the physical quantity concerning welding, thus acquiring operating information (step S13).

In step S2, the operating information storage unit 18 acquires operating information from the collection unit 11 and records the acquired operating information thereon (step S14). At this time, the operating information storage unit 18 performs recording while associating the operating information with sales information stored in the sales information storage unit 17 (step S15).

In step S3, the prediction unit 19 acquires operating information from the operating information storage unit 18 (step S16). Moreover, the prediction unit 19 acquires sales information from the sales information storage unit 17 (step S17). The prediction unit 19 performs machine learning based on these acquired pieces of information and updates an estimation model for performing a failure prediction (step S18). Furthermore, the estimation model can be updated at various timings such as each time new sales information is recorded on the sales information storage unit 17.

In step S4, the prediction unit 19 acquires a predicted time point of failure based on the estimation model (step S19). The prediction unit 19 outputs the acquired predicted time point of failure to the notification unit 14 and the ordering unit 15 (steps S20 and S21).

In step S5, the notification unit 14 determines whether the time to the predicted time point of failure is less than a preliminarily set notification time. If the notification unit 14 has determined that the time is less than the notification time (YES in step S5), then in step S6, the notification unit 14 notifies the user terminal 6 that the time to a time point at which the device or component is predicted to fail is less than a time equivalent to the notification time (step S22). In response to receiving this notification, the user can perform necessary maintenance or an ordering operation for a replacement component or the like. This enables reducing a downtime caused by an unexpended failure.

In step S7, the ordering unit 15 determines whether the time to the predicted time point of failure is less than a preliminarily set ordering time. If the ordering unit 15 has determined that the time is less than the ordering time (YES in step S7), then in step S8, the ordering unit 15 performs order processing for a device or component the replacement of which is necessary due to a failure (step S23). This processing is performed by, without the user performing order processing, the device state monitoring system 1 automatically determining a necessary device or component. The ordering unit 15 refers to a quantity in stock for the user recorded on the sales information storage unit 17, thus being able to also determine an order quantity. This enables the user to save the trouble of performing an ordering operation, so that stock control can be automated. Moreover, the seller is also enabled to save the trouble of an interaction with the user. If the notification unit 14 has determined that the time is not less than the notification time (NO in step S5), if the ordering unit 15 has determined that the time is not less than the ordering time (NO in step S7), and after step S8 is performed, the device state monitoring system 1 returns the processing to step S1, so that the processing is repeatedly performed during a period in which the production line 3 is operating.

Next, alternative product suggestion processing which is performed by the device state monitoring system 1 is described.

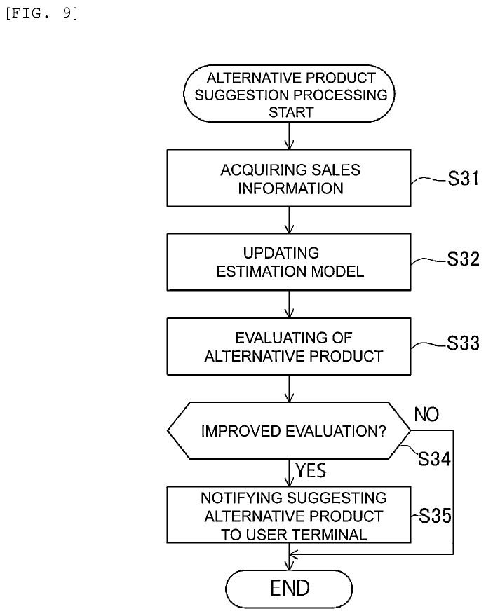

FIG. 9 is a flowchart used to explain alternative product suggestion processing which is performed by the device state monitoring system 1. This alternative product suggestion processing can be performed at a fixed frequency or can be performed at predetermined timing (for example, timing of failure of a device or component). While processing corresponding to the alternative product suggestion processing is illustrated following the sequence diagram of FIG. 8, timing at which the processing is performed is not limited to this.

In step S31, the suggestion unit 20 acquires sales information and alternative product information from the sales information storage unit 17 as needed (step S41 illustrated in FIG. 8). For example, the sales information and alternative product information are input by the seller terminal 4 as needed and are recorded on the sales information storage unit 17 (step S42 illustrated in FIG. 8).

In step S32, the suggestion unit 20 performs machine learning based on the acquired information, and updates an estimation model for estimating a predicted time point of failure corresponding to the device or component (step S44). In step S33, the suggestion unit 20 performs the evaluation of a case where an alternative product has been used, based on the estimation model (step S45). Furthermore, the estimation model can be updated at various timings such as each time new sales information is recorded on the sales information storage unit 17.

As an example, the evaluation of a welding tip can be performed with use of abrasion, which is determinable from a welding current and a welding voltage. The suggestion unit 20 selects a welding tip serving as an alternative product which reduces abrasion and increases productivity, based on the estimation model. For example, the suggestion unit 20 calculates the cost of a welding tip occurring for a fixed period from a replacement cycle and price of a welding tip in current use. Moreover, the suggestion unit 20 calculates the cost of a welding tip occurring for a fixed period from a replacement cycle and price of a welding tip which are predicted in a case where a welding tip serving as an alternative product has been used. The suggestion unit 20 compares these calculated costs with each other, and, if the cost in a case where the alternative product has been used is the smaller one, the suggestion unit 20 can evaluate that the alternative product should be used.

Moreover, as another example, the evaluation of a welding wire can be performed with use of transmission line resistance, which is determinable from a current and voltage of a transmission line motor for the wire. The suggestion unit 20 selects a welding wire serving as an alternative product which reduces transmission line resistance, based on the estimation model. The suggestion unit 20 compares a welding wire in current use and a welding wire serving as an alternative product with each other while settings, as evaluation items, for example, an exchange frequency, a yield rate, and the number of times of stoppage or idle running (what is called short time breakdown in the production line) caused by a primary trouble arising from a wire. If the alternative product is given a better evaluation, the suggestion unit 20 can evaluate that the alternative product should be used.

In step S34, the suggestion unit 20 determines whether a case where the alternative product is used is given an improved evaluation as compared with a case where a device or component in current use is used. If the suggestion unit 20 has determined that a case where the alternative product is used is given an improved evaluation (YES in step S34), the suggestion unit 20 outputs such evaluation information to the notification unit 14 (step S46). In step S35, the notification unit 14 performs notification indicating the content of suggesting an alternative product to the user terminal 6 based on the evaluation information (step S47). On the other hand, if the suggestion unit 20 has determined that a case where the alternative product is used is not given an improved evaluation (NO in step S34), the suggestion unit 20 ends the processing.

The device state monitoring system 1 configured as described above stores operating information acquired from the production line 3 in a system such as a customer relations management (CRM) system which is managed by the seller and which retains customer information or sales information, while associating the operating information and the customer information or sales information with each other, so that the seller can obtain information in which sales information concerning a sales history, a maintenance history, or a modification history, which the seller itself has and holds, and operating information are associated with each other, without taking time and labor of inputting the information or collection or inputting of device information. The device state monitoring system 1 performs machine learning based on such information, thus being able to perform a high-accuracy failure prediction suitable for the real situation.

Moreover, since the seller is able to obtain information concerning a failure prediction, the device state monitoring system 1 is able to also utilize the information for a sales forecast by the seller itself or for a production forecast and sales forecast by a manufacturer which sells products or components to the seller. As a result, the seller or the manufacturer is able to achieve the advantage of being able to predict appropriate supply timing or supply quantity of products or components and being also able to suggest supplementation before running out of stock. Additionally, the manufacturer is able to quantitatively recognize a target for product development.

In the case of being a CRM system for managing information concerning users for the seller, the device state monitoring system 1 is able to use, in a cross-sectoral manner, information concerning the same type of device or component which is obtained from a plurality of users for the seller and is, therefore, able to obtain a larger quantity of information and perform a higher-accuracy prediction. Therefore, the device state monitoring system 1 is a system which is capable of implementing sharing of production information between a plurality of companies (a plurality of users, a plurality of sellers, or a plurality of manufacturers) and provision of optimization and improvement policies.

While some embodiments of the present invention have been described, these embodiments are the ones presented as examples and are not intended to limit the scope of the invention. These novel embodiments can be implemented in other various configurations and can be subjected to various types of omission, replacement, or alteration without departing from the gist of the invention. These embodiments and modifications thereof are not only included in the scope or gist of the invention but also included in the scope of the invention set forth in the claims and its equivalence.

For example, the configuration of the production line 3 illustrated in FIG. 1 is merely an example, and the PLC 32, the PLC-GW 33, and the dedicated circuit board 39 can be omitted, so that a physical quantity concerning welding can be configured to be directly transmitted from, for example, the robot controller 38 to the network 2.

The seller terminal 4, the manufacturer terminal 5, and the user terminal 6 are not essential, and, moreover, each of the computation unit 13, the notification unit 14, and the ordering unit 15 for analysis using process information is also not a constituent element essential for a device state monitoring system of the present invention. Moreover, transmitting operating information via the network 2 is also not essential, and the device state monitoring system 1 can be implemented on a closed network such as an in-house network.

The term “dealer” refers to a person or company that sells devices or components to the user, and, in a case where the manufacturer directly sells these to the user, the manufacturer is included in the term “dealer”.

While, in FIG. 1, an example in which all of the units of the device state monitoring system 1 are included in the same system is illustrated, a part thereof can be included in a different system via the network 2. For example, the collection unit 11 or the computation unit 13 can be configured to use different SaaS.

The device state monitoring system 1 can be, for example, a customer relations management (CRM) system for the seller, and can be the one which is used for, for example, management and analysis of customer information.

While an example in which the device state monitoring system 1 is applied to monitoring of the state of a welding or processing system has been used for description, the device state monitoring system 1 can be applied to not only manufacturing business but also any type of business as long as it includes equipment or facilities in which a device that executes a series of processes is used, such as a construction site, any type of plant, a commercial facility, or a medical facility.

### REFERENCE SIGNS LIST

1 Device state monitoring system
2 Network
3 Production line
4 Seller terminal
5 Manufacturer terminal
6 User terminals
11 Collection unit
12 Storage unit
13 Computation unit
14 Notification unit
15 Ordering unit
17 Sales information storage unit
18 Operating information storage unit
19 Prediction unit
20 Suggestion unit
21 Process determination unit
22 Display control unit
31, 31a, 31b, 31c Cell
32, 32a, 32b PLC
33 PLC-GW
34 Communication GW
35 Welding system
36 Robot body
37 variety of jigs and sensors
38 Robot controller
39 Dedicated circuit board

1. A device state monitoring system comprising:
a collection unit that acquires, from a device which executes a series of processes, operating information about the device in a time-series manner; and
a process determination unit that performs matching of the operating information acquired by the collection unit with matching data obtained by modeling the operating information acquired from the device when the device is in each of the processes, and determines process information concerning the process which the device is executing.

2. The device state monitoring system according to claim 1,
wherein the device includes a plurality of operating elements capable of taking a predetermined state,
wherein the operating information includes element information representing whether a predetermined state is established in each of the operating elements, and
wherein the matching data is data obtained by modeling a pattern of the element information included in the operating information.

3. The device state monitoring system according to claim 1, wherein the process includes a main operation which the device performs and an operation which occurs concomitantly with the main operation.

4. The device state monitoring system according to claim 3, wherein the main operation includes a processing operation for directly producing a processed product by the device, and the operation which occurs concomitantly with the main operation includes a set-up change operation, a subsequent operation, waiting, and a troubleshooting operation.

5. The device state monitoring system according to claim 2, wherein the process includes a main operation which the device performs and an operation which occurs concomitantly with the main operation.

6. The device state monitoring system according to claim 5, wherein the main operation includes a processing operation for directly producing a processed product by the device, and the operation which occurs concomitantly with the main operation includes a set-up change operation, a subsequent operation, waiting, and a troubleshooting operation.
